(19) United States
(12) Patent Application Publication
(10) Pub. No.: US 2013/0307769 A1
(43) Pub. Date: Nov. 21, 2013

(54) MOBILE DEVICE ACTIVATION BY USER GRASP

(71) Applicants: Sangita Sharma, Portland, OR (US); David L. Graumann, Portland, OR (US); Giuseppe Raffa, Portland, OR (US)

(72) Inventors: Sangita Sharma, Portland, OR (US); David L. Graumann, Portland, OR (US); Giuseppe Raffa, Portland, OR (US)

(21) Appl. No.: 13/995,450

(22) PCT Filed: Sep. 30, 2011
(86) PCT No.: PCT/US11/54375

§ 371 Date: Aug. 5, 2013

(51) Int. Cl. G06F 3/02

(52) U.S. Cl. CPC G06F 3/0227
USPC 345/156

(57) ABSTRACT

Method and apparatus for mobile device activation by user grasp. An embodiment of a mobile device includes a cover, the cover including at least a first side and a least a first corner, the first corner adjoining the first side, with a concave indentation in the cover, the concave indentation being located at the first corner of the mobile device. The mobile device further includes a first touch sensor located in the concave indentation, the first touch sensor to generate a signal upon physical contact or proximity with a user of the mobile device, and an activation module, the activation module to transition the mobile device from a deactivated state to an activated state upon receiving at least the first signal from the first touch sensor.

### TECHNICAL FIELD

Embodiments of the invention generally relate to the field of electronic devices and, more particularly, to mobile device activation by user grasp.

### BACKGROUND

Mobile devices, including cellular phones, smart phones, mobile Internet devices (MIDs), handheld computers, personal digital assistants (PDAs), and other similar devices, are will commonly be grasped in a hand for operation. In many circumstances, the holding of the device will be followed by an input into one or more applications or services.

However, conventional devices require certain actions, and potentially several actions, before the user can begin access in the appropriate application or service. For example, the user generally will be required to turn the device on or otherwise return the device to an operational state before any other action can be taken because the device will most likely be placed into an off or other low power state to reduce power usage. The operation of such a system results in time usage and repeated operations each time the mobile device is activated before the user is able to engage in actual operations.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an embodiment of a mobile device;

FIG. 2 illustrates an embodiment of an activate touch sensor portion of a mobile device;

FIG. 3 is an illustration of an embodiment of a device or system to be activated by user grasp;

FIG. 4 is an illustration of elements of an embodiment of a device or system allowing activation by grasp of a user;

FIG. 5 is a flowchart to illustrate an embodiment of a process for activation of a device or system; and

FIG. 6 illustrates an embodiment of a device or system allowing for activation by user grasp.

### DETAILED DESCRIPTION

Embodiments of the invention are generally directed to mobile device activation by user grasp.

As used herein:

“Mobile device” means a mobile electronic device or system including a cellular phone, smart phone, mobile Internet device (MID), handheld computers, personal digital assistants (PDAs), and other similar devices.

“Touch sensor” means a sensor that is configured to provide input signals that are generated by the physical contact of a user, proximity of a user, or both (which may generally be referred to as contact with the touch sensor), including a sensor that detects contact by a thumb or other finger of a user of a device or system, including a mobile device. A touch sensor may include, but is not limited to, a capacitive sensor, which may detect the contact of a finger or hand on the capacitive sensor. A touch sensor may include a sensor used for multiple different purposes in the operation of a device or system.

“Side touch sensor” means a touch sensor that detects contact of a user, including a user's finger or hand, on at least one side of a device or system including a mobile device. A side touch sensor includes a touch sensor that is physically located at least in part on one at least one side of the mobile device, or a side touch sensor that detects contact with a user on the side of the mobile device without being physically located on the side on the mobile device.

“Activate” means to transition a device or system to activate, enable, or allow an operation or usage of the device or system. “Activation” includes turning a device or system on, unlocking the device or system, enabling a certain application or function of the mobile device, transitioning a device or system to a higher state of operation (including an operational or other higher power state), or otherwise activating an operation or usage of the device or system. Similarly, “deactivate” means to transition a device or system to deactivate, disable, or disallow an operation or usage of the device or system. “Deactivation” includes turning a device or system off, locking the device or system, disabling a certain application or function of the mobile device, transitioning a device or system to a lower state of operation (including a hibernation or other lower power state), or otherwise deactivating an operation or usage of the device or system.

In some embodiments, a mobile device includes a form factor including a touch sensor that allows a user to activate the mobile device for operation through a natural grasp of the mobile device by the contact of at least one finger with the touch sensor. Such touch sensor is generally referred to herein as an “activate touch sensor”. For simplicity the figures herein generally provided a device having a single activate touch sensor, but embodiments are not limited to this implementation, and may include one or more activate touch sensors. In addition, for simplicity the figures herein generally illustrate a finger pad touch sensor on a certain side of a mobile device, such as on a left side for contact when grasped by the right hand of a user, but embodiments are not limited to this implementation, and may include one or more activate touch sensors on either or both sides of a mobile device.

In some embodiments, a mobile device includes at least one concave indentation at a corner of the mobile device, the concave indentation including an activate touch sensor. In some embodiments, the concave indentation is located at a bottom corner of the mobile device, where the bottom of a mobile device is defined as the lower side of the mobile device when the mobile device is placed in its normal position for viewing and/or use by a user. In some embodiments, the concave indentation is placed and shaped such that the small finger of a user may fit at least in part within such indentation, and such that the mobile device may at least in part rest on such finger when the hand of the user is wrapped around the mobile device.

In some embodiments, a mobile device includes a cover also having at least one side with additional contours forming concave indentations that provide elements for placing fingers of a user when grasping the mobile device in a firm grasp. In some embodiments, a mobile device includes at one activate touch sensor placed in an area that may be reached by a finger of a user when the hand of the user is grasping the mobile device using the contours to direct the placement of the figures of the user. Such contours may exist on either or both sides of a mobile device.

In some embodiments, a mobile device provides a convenient and natural method for activating a mobile device, such as turning on (or returning the device to an operational power state), unlocking the mobile device, or both, while grasping the device in a secure and natural position. In some embodiments, the concave indentation in the device allows for activating the mobile device when the mobile device is intentionally grasped by the user, but provides a touch sensor that won't normally be contacted by a user in other circumstances.

In some embodiments, a mobile device includes at least one additional touch sensor, the additional touch sensor being a side touch sensor that is operated by the contact with a finger of the user. In some embodiments, the side touch sensor is on an opposite side as the activate touch sensor, such as a circumstance in which the side touch sensor is operated by a thumb of a user. While the figures herein generally illustrate a mobile device having a side touch sensor on a certain side of the mobile device, embodiments are not limited to this implementation, and may include a side touch sensor for either or both sides of a mobile device. In some embodiments, the activate touch sensor operates in conjunction with the side touch sensor for at least certain operations.

In some embodiments, the activate touch sensor further provides a function of activating the operation of the side touch sensor. In some embodiments, subsequent to the activation of a mobile device utilizing the activate touch sensor, the side touch sensor is activated when a finger of the user is in contact with the activate touch sensor, and is deactivated when a finger of the user is not in contact with the activate touch sensor.

In some embodiments, a mobile device is operable to be activated if both the activate touch sensor and the side touch sensor are engaged at the same time, such as when a finger of a user is in contact with the activate touch sensor and the thumb of the user is in contact with the side touch sensor.

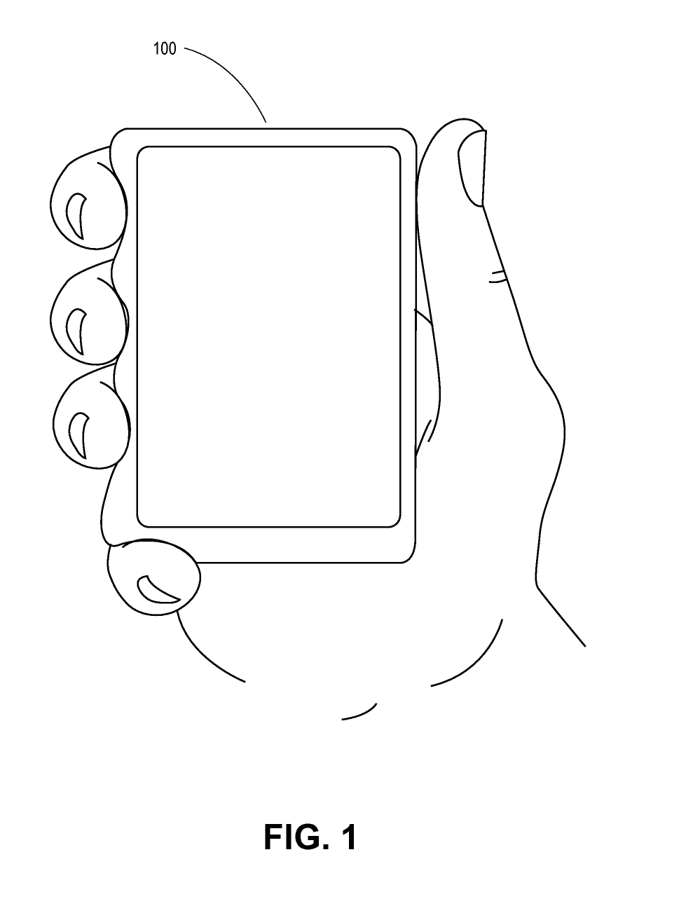

FIG. 1 illustrates an embodiment of a mobile device to be activated by user grasp. In some embodiments, a mobile device 100 includes a unique form-factor allowing for a natural engagement of the mobile device. In some embodiments, the mobile device has a concave indentation, such as on a bottom corner of the mobile device. In some embodiments, a touch sensor is placed on an inner surface of this indentation, such as in a bottom corner of the mobile device. The concave indentation may be utilized to provide a natural anchor position for a finger (the small or pinky finger if the concave indentation is placed in a bottom corner of the mobile device) when the user is positioning the mobile device in the user's hand for operation.

In some embodiments, when the activate touch sensor detects contact with a user's finger, the activate touch sensor provides a signal that results in the mobile device automatically activating itself (such as automatically unlocking the mobile device and/or returning the mobile device to an operational power state). In some embodiments, the contact of the finger of a user provides a substitute for the need to reach the power button (or other button) on a mobile device in order to unlock it. In some embodiments, the physical arrangement of the touch sensor and the shape of the mobile device assist in preventing the mobile device from being inadvertently triggered when the mobile device is, for example, being removed from a pocket or purse.

In some embodiments, in addition to operating to activate the mobile device, either by itself or in conjunction with a side touch sensor, the activate touch sensor may also operate to activate and deactivate the side touch sensor of a mobile device. In some embodiments, the side touch sensor may only be active when a finger of the user is in contact with the activate touch sensor, thus removing the need for the side touch sensor to be active at all times, and thus reducing likelihood that there will be unexpected behavior if the side touch sensor is contacted inadvertently.

In some embodiments, the activate touch sensor may be used in cooperation with time out conditions for the mobile device. In some embodiments, the activate touch sensor may be utilized such that the mobile device will not time out (and return to a deactivated state) as long as there is contact detected on the activate touch sensor, with, for example, the time out period not beginning to run until the user releases the activate touch sensor. In an example, the activate touch sensor may optionally be used to reduce the amount of time for a mobile device time out condition, with the mobile device being locked more quickly after releasing the activate touch sensor than a time out for a conventional mobile device, thereby increasing the security of data held on the mobile device. In some embodiments, the activate touch sensor may be used in cooperation with power saving methods of the mobile device. In an example, the activation mechanism will direct the device to enter a low power mode faster than a time out mechanism.

In some embodiments, as shown in FIG. 1, the mobile device 100 further includes one or more additional indentations for one or more additional fingers. For example, a mobile device may include three additional indentations on the same side of the device as the concave indentation that may be utilized to provide anchor positions for the three fingers (index/middle/ring) in addition to the pinky, where the pinky is placed in the concave portion. In some embodiments, the mobile device shape provides natural comfort locations for holding the device that add to the user experience in terms feeling the device is adequately supported and stable while using the mobile device.

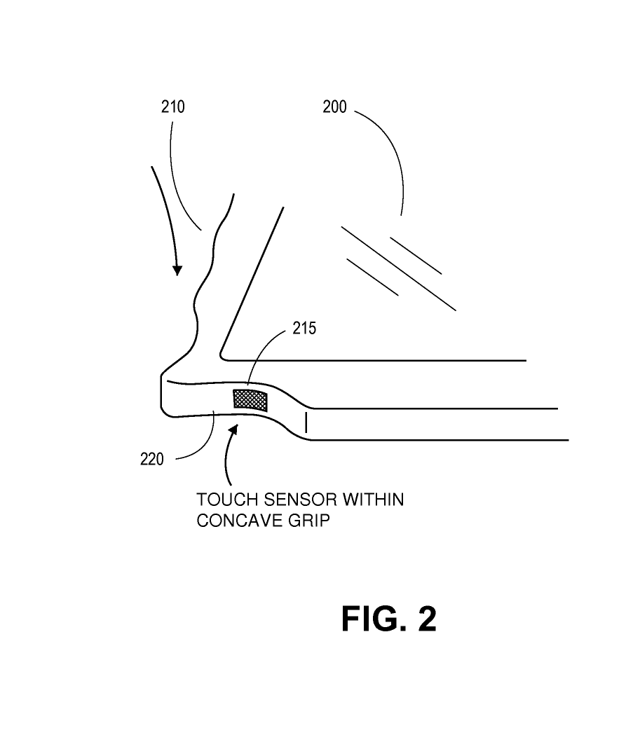

FIG. 2 illustrates an embodiment of an activate touch sensor portion of a mobile device. In some embodiments, a mobile device 200 includes a concave indentation 220, where the concave indentation is located at a corner of the mobile device 200 and which may be used for stabilizing and supporting the grasp of a user around the mobile device 200. In some embodiments, the concave indentation includes an activate touch sensor 215 for use in activating the mobile device 200 when the device is grasped by the hand of a user, where a finger of the hand of the user may be wrapped around the concave indentation 220. In some embodiments, the mobile device 200 may include one or more addition concave elements 210 on a same side of the mobile device as the concave indentation 220 for use in placing other fingers of the user when grasping the mobile device.

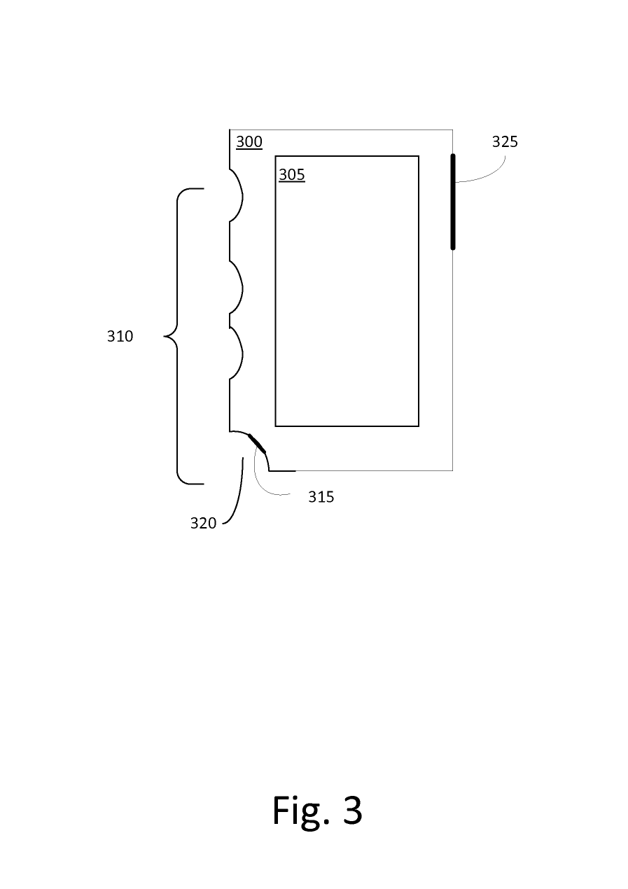

FIG. 3 is an illustration of an embodiment of a device or system to be activated by user grasp. As illustrated, an embodiment of a device or system 300 (referred to here generally as a mobile device) may include a screen 305 for viewing data, which may further be a touch screen for the input of information and commands to the mobile device 300. In some embodiments, the mobile device 300 includes a side touch sensor 325 for input of commands by a user using certain gestures. In this illustration the side touch sensor 325 is shown as being physically located in the surface of a side of the mobile device 300, but embodiments are not limited to this physical infrastructure. In some embodiments, the touch sensor 325 may include capacitive sensors and may also include other sensors, such as an optical sensor. See, for example, U.S. patent application Ser. No. 12/650,582, filed Dec. 31, 2009 (Optical Capacitive Thumb Control with Pressure Sensor); U.S. patent application Ser. No. 12/646,220, filed Dec. 23, 2009 (Contoured Thumb Touch Sensor Apparatus). In some embodiments, the concave indentations may be located symmetrically on both sides of the device 300 to allow for both left and right hand operation indistinctively. In some embodiments, the device may detect how the user is handling the device, and may modify operations in response to such detection. In an example, the device may change the display content orientation based on such information, such as changing a virtual keyboard layout to adapt to thumb position on the left or right of the device 300.

In some embodiments, the mobile device 300 includes a concave indentation 320, such as the indentation 220 illustrated in FIG. 2, where the concave indentation 320 is located at a corner of the device 300 and may be used for stabilizing and supporting the grasp of a user around the device or system 300. In some embodiments, the concave indentation includes an activate touch sensor 315 for use in activating the mobile device 300 when grasped by the hand of a user, where a finger of the hand of the user may be wrapped around the concave indentation 320. In some embodiments, activation of the mobile device 300 includes activation of the screen 305 for usage or operation by the user of the mobile device.

In some embodiments, the mobile device 300 may include one or more additional concave elements 310 on a same side of the mobile device as the concave indentation 320 for use in placing other fingers of the user when grasping the mobile device. The additional concave elements may or may not be evenly spaced along the side of the mobile device 300.

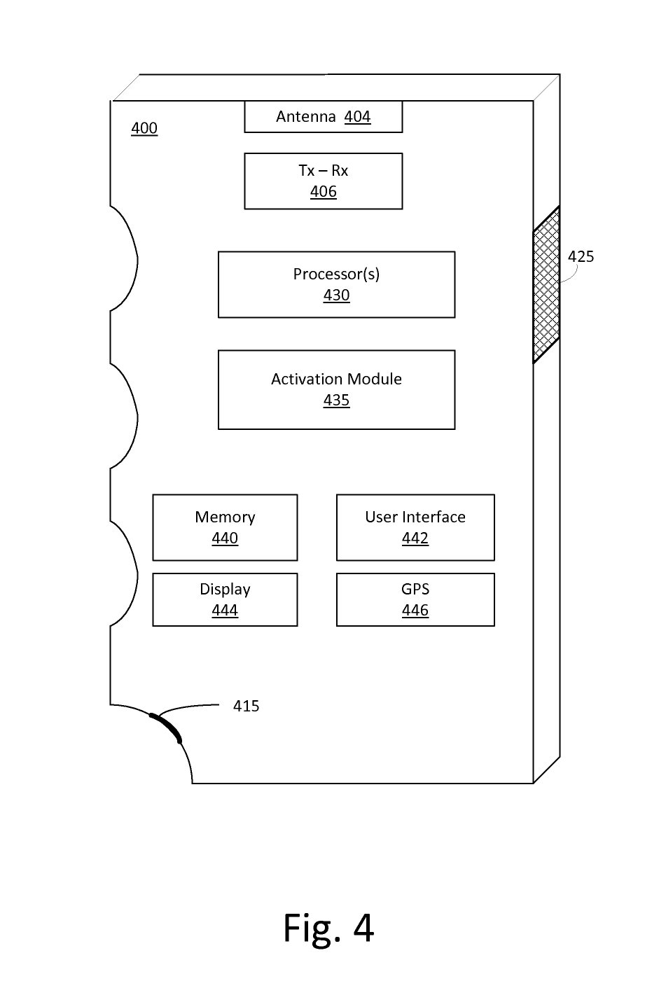

FIG. 4 is an illustration of an embodiment of elements of a device or system allowing activation by grasp of a user. In some embodiments, a device or system 400 (generally referred to as a mobile device) includes a first touch sensor, the first touch sensor being an activate touch sensor 415 that may be accessed by a finger of a user when grasping the mobile device 400. In some embodiments, the mobile device 400 may further include a second touch sensor, the second touch sensor being a side touch sensor 425 for use in providing input to the mobile device through gesture operations of a thumb or other finger of the user. In some embodiments, the first touch sensor 415 and the second touch sensor 425 may operate in cooperation with each other, such as, in a first example, the mobile device being activated when contact is made with both the first touch sensor and the second touch sensor, or, in a second example, the second touch sensor being activated to accept input only when contact is made with the first touch sensor.

In some embodiments, the mobile device 400 further includes one or more processors 430 for the processing of signals and commands. In some embodiments, the mobile device 400 includes an activation module or algorithm 435 that receives signals from the first touch sensor, or both the first and second touch sensors, and provides for activation of the mobile device when contact is made with the first touch sensor 415 or when contact is made with both the first touch sensor and the second touch sensor.

The mobile device may further include, for example, one or more transmitters and receivers 406 for the wireless transmission and reception of data, as well as one or more antennas 404 for such data transmission and reception; a memory 440 for the storage of data; a user interface 442, including a graphical user interface (GUI), for communications between the mobile device 400 and a user of the device; a display circuit or controller 444 for providing a visual display to a user of the mobile device 400; and a location circuit or element, including a (GPS) circuit or element 446.

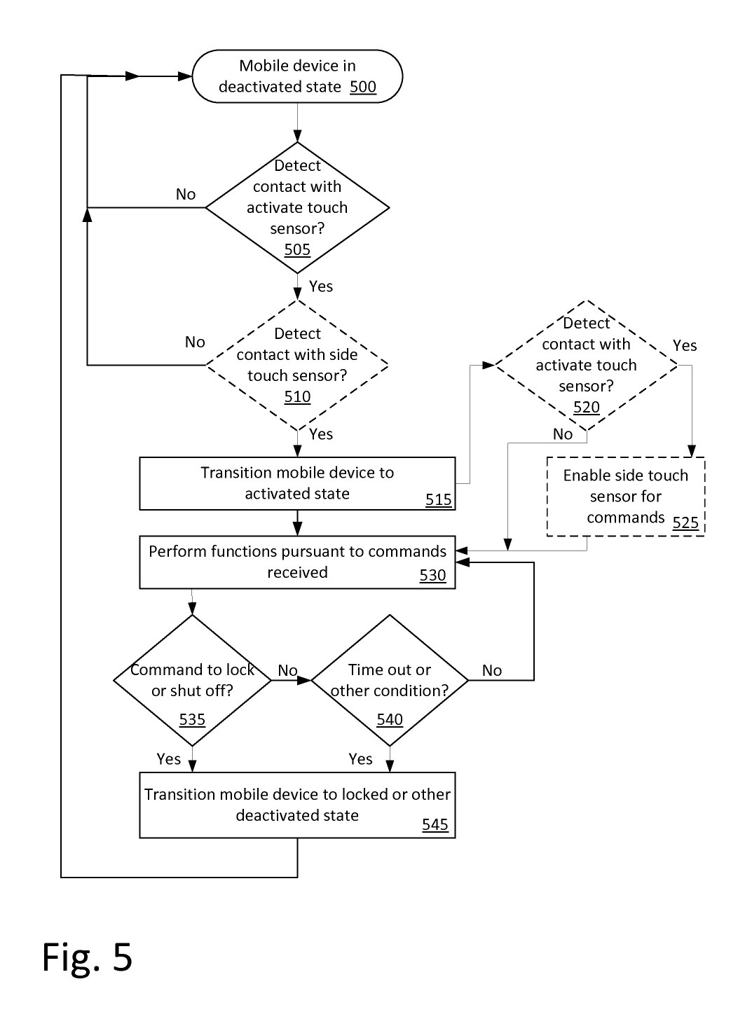

FIG. 5 is a flowchart to illustrate an embodiment of a process for activation of a device or system. In some embodiments, a mobile device may be in a deactivated state 500, such as the mobile device being locked, in a lower power state (turned off or in hibernation), or both. In some embodiments, upon detection of contact with an activate touch sensor 505 (such as activate touch sensor 315 illustrated in FIG. 3), or upon the additional detection of contact with a side touch sensor (such as side touch sensor 325 illustrated in FIG. 3), the mobile device transitions into an activated state 515, where transitioning the mobile device into an activated state may include unlocking the mobile device, returning the mobile device to an operational power state, or both.

In some embodiments, the mobile device may then perform functions pursuant to received commands 530. In some embodiments, the mobile device may also determine whether contact is detected with the activate touch sensor 520, and, if so, the side touch sensor is enabled to receive commands 525.

In some embodiments, upon receiving a command to lock the mobile device or to place the device in a low power (such as off) state, or upon a time out or other condition (such as a certain period of time when the no commands have been received and the touch sensor is not contacted), the mobile may be transitioned back to a locked or other deactivated state 545, then returning to the deactivated state 500.

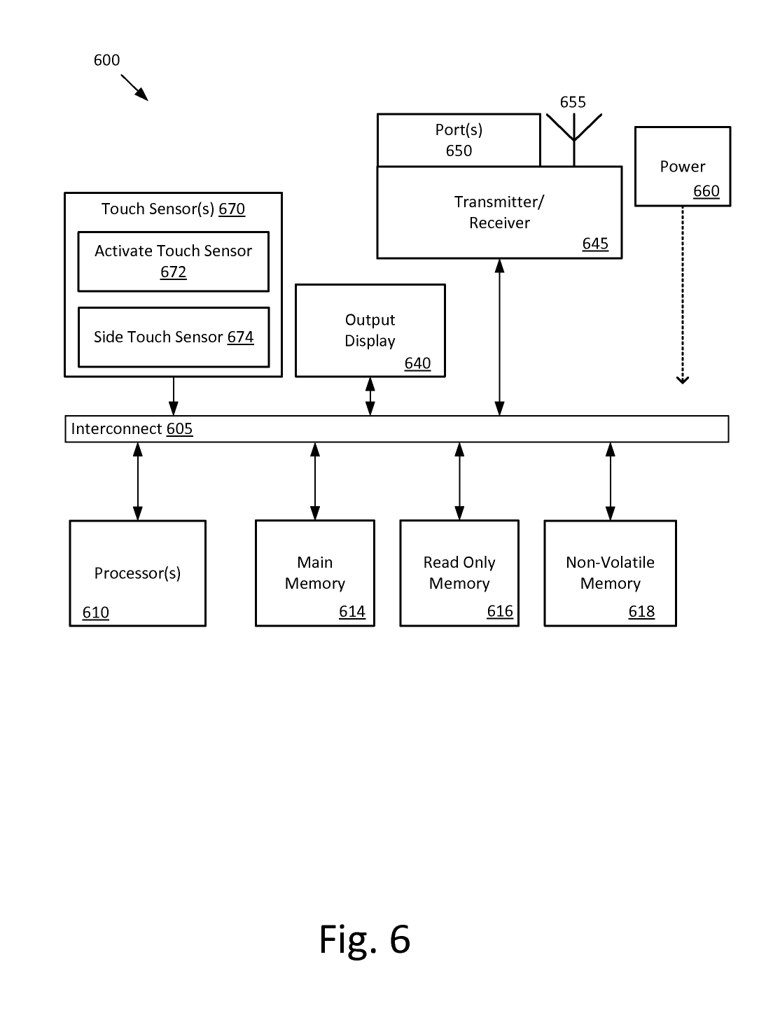

FIG. 6 illustrates an embodiment of a device or system allowing for activation by user grasp. In this illustration, certain standard and well-known components that are not germane to the present description are not shown. Under some embodiments, a mobile device 600 comprises an interconnect or crossbar 605 or other communication means for transmission of data. The device 600 may include a processing means such as one or more processors 610 coupled with the interconnect 605 for processing information. The processors 610 may comprise one or more physical processors and one or more logical processors. The interconnect 605 is illustrated as a single interconnect for simplicity, but may represent multiple different interconnects or buses and the component connections to such interconnects may vary. The interconnect 605 shown in FIG. 6 is an abstraction that represents any one or more separate physical buses, point-to-point connections, or both connected by appropriate bridges, adapters, or controllers.

In some embodiments, the device 600 includes one or more touch sensors 670. In some embodiments, the touch sensors 670 may includes capacitive sensors, and may include one or more other sensors, such as optical sensors. The touch sensors 670 include an activate touch sensor 672, such as activate touch sensor 315 illustrated in FIG. 3. The touch sensors may further include a side touch sensor 674, such as side touch sensor 325 as illustrated in FIG. 3. In some embodiments, the one or more touch sensors are utilized to activate the mobile device 600 when the mobile device is grasped by a user of the device.

In some embodiments, the device 600 further comprises a random access memory (RAM) or other dynamic storage device or element as a main memory 614 for storing information and instructions to be executed by the processors 610. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may include certain registers or other special purpose memory. The device 600 also may comprise a read only memory (ROM) 616 or other static storage device for storing static information and instructions for the processors 610. The device 600 may include one or more non-volatile memory elements 618 for the storage of certain elements.

The device 600 may also be coupled via the interconnect 605 to an output display 640. In some embodiments, the display 640 may include a liquid crystal display (LCD) or any other display technology, for displaying information or content to a user. In some environments, the display 640 may include a touch-screen that is also utilized as at least a part of an input device, and which may be activated when the mobile device is grasped by a user of the device. In some environments, the display 640 may be or may include an audio device, such as a speaker for providing audio information.

One or more transmitters or receivers 645 may also be coupled to the interconnect 605. In some embodiments, the device 600 may include one or more ports 650 for the reception or transmission of data. The device 600 may further include one or more antennas 655 for the reception of data via radio signals.

The device 600 may also comprise a power device or system 660, which may comprise a power supply, a battery, a solar cell, a fuel cell, or other system or device for providing or generating power. The power provided by the power device or system 660 may be distributed as required to elements of the device 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A mobile device comprising:
a cover, the cover including at least a first side and at least a first corner, the first corner adjoining the first side;
a concave indentation in the cover, the concave indentation being located at the first corner of the mobile device;
a first touch sensor located in the concave indentation, the first touch sensor to generate a signal upon physical contact or proximity with a user of the mobile device; and
an activation module, the activation module to transition the mobile device from a deactivated state to an activated state upon receiving at least the first signal from the first touch sensor.

2. The mobile device of claim 1, wherein the cover includes one or more additional concave indentations in the first side of the mobile device.

3. The mobile device of claim 1, wherein transitioning the mobile device to an activated state includes one or more of unlocking the mobile device or transitioning the mobile device to an operational power state.

4. The mobile device of claim 1, further comprising a second touch sensor, wherein the second touch sensor is located in a second side of the mobile device, the second side being an opposite side to the first side.

5. (canceled)

6. The mobile device of claim 4, wherein the second touch sensor may be utilized for providing input to the mobile device through gestures detected by the second touch sensor.

7. The mobile device of claim 4, wherein the activation module is to activate the mobile device upon receiving a signal from the second touch sensor at a same time as the signal from the first touch sensor.

8. The mobile device of claim 4, wherein the mobile device is to activate operation of the second touch sensor during time periods when the first signal is received from the first touch sensor.

9. The mobile device of claim 1, wherein the mobile device commences timing for a time out period for the mobile device when the first signal is no longer generated by the first touch sensor.

10. A method comprising:
receiving a first signal at an activation module of a mobile device from a first touch sensor of the mobile device, the mobile device being in a deactivated state;
transitioning the mobile device from the deactivated state to an activated state based at least in part on the signal from the first touch sensor; and
operating the mobile device in the activated state;
wherein the first touch sensor is a touch sensor located in a first corner adjacent to a first side of the mobile device, and wherein the first touch sensor provides the signal when there is physical contact or proximity with a user of the mobile device.

11. The method of claim 10, wherein the mobile device further includes a second touch sensor, the second touch sensor being located in a second side of the mobile device, the second side being an opposite side to the first side, the second touch sensor producing a second signal when there is physical contact or proximity with a user of the mobile device.

12. The method of claim 11, wherein transitioning the mobile device to the activated state is further based on receiving the second signal from the second touch sensor at a same time as the first signal from the first touch sensor.

13. The method of claim 11, further comprising activating the second sensor for providing input to the mobile device while the first signal is generated by the first touch sensor.

14. The method of claim 10, further comprising commencing timing for a time out period for the mobile device when the first signal is no longer generated by the first touch sensor.

15. The method of claim 10, further comprising commencing a low power state for the mobile device when the first signal is no longer generated by the first touch sensor.

16. A system comprising:
a touch screen for the input of data by a user;
a cover, the cover including at least a first side and at least a first corner, the first corner adjoining the first side;
a concave indentation in the cover, the concave indentation being located at the first corner of the system;
a first touch sensor located in the concave indentation, the first touch sensor to generate a signal upon physical contact or proximity with the user of the system; and
an activation module, the activation module to transition the system from a deactivated state to an activated state upon receiving at least the first signal from the first touch sensor, activation of the system including activation of the touch screen.

17. The system of claim 16, wherein the cover includes one or more additional concave indentations in the first side of the cover.

18. The system of claim 16, wherein transitioning the system to an activated state includes one or more of unlocking the system or transitioning the system to an operational power state.

19. The system of claim 16, further comprising a second touch sensor located in a second side of the cover, the second side being an opposite side to the first side, the second touch sensor being operational to detect gestures by the user.

20. The system of claim 19, wherein the activation module is to activate the system upon receiving a signal from the second touch sensor at a same time as the signal from the first touch sensor.

21. The system of claim 19, wherein the system is to activate operation of the second touch sensor to detect gestures during time periods when the first signal is received from the first touch sensor.

22. The system of claim 16, wherein the system commences timing for a time out period to deactivate the system when the first signal is no longer generated by the first touch sensor.

23. A non-transitory computer-readable medium having stored thereon data representing sequences of instructions that, when executed by a processor, cause the processor to perform operations comprising:
determining that there is contact with a first touch sensor of a mobile device, the mobile device being in a deactivated state;
transitioning the mobile device from the deactivated state to an activated state based at least in part on the signal from the first touch sensor; and
operating the mobile device in the activated state;
wherein the first touch sensor is a touch sensor located in a first corner adjacent to a first side of the mobile device.

24. The medium of claim 23, wherein transitioning the mobile device to the activated state is further based on determining that there is contact with a second touch sensor at a same time as the contact with the first touch sensor.

25. The medium of claim 23, further comprising instructions that, when executed by the processor, cause the processor to perform operations comprising:
activating a second sensor for providing input to the mobile device while there is contact with the first touch sensor.

26. The medium of claim 23, further comprising instructions that, when executed by the processor, cause the processor to perform operations comprising:
commencing timing for a time out period for the mobile device when the contact with the first touch sensor ends.
